(19) United States
(12) Patent Application Publication
(10) Pub. No.: US 2010/0121693 A1
(43) Pub. Date: May 13, 2010

(54) DIGITAL ADVERTISING DISPLAY APPARATUS AND METHOD FOR PROVIDING CONTROLLED CONTENT TO A DIGITAL ADVERTISING DISPLAY

(76) Inventor: Genevieve Pacana, Glendale, CA (US)

Correspondence Address: MARC E. HANKIN, ESQ., 11414 THURSTON CIRCLE, LOS ANGELES, CA, 90049, US

(21) Appl. No.: 12/404,084

(22) Filed: Mar. 13, 2009

Related U.S. Application Data
(60) Provisional application No. 61/114,421, filed on Nov. 13, 2008.

(51) Int. Cl. G06Q 30/00; G06F 3/041; G09G 3/36; G08B 21/00

(52) U.S. Cl. 705/14.4; 345/173; 345/87; 340/573.1

(57) ABSTRACT

Various embodiments of this invention disclose a digital advertising display apparatus and method of providing controlled content to a digital advertising display. The digital advertising display may be located in a public, private, or retail space. The content provided may be an advertisement that is related to a specific product, informational, educational, or artistic. The content is delivered through wireless communications.

### CROSS-REFERENCE TO RELATED APPLICATIONS

This application claims priority to the filing date, Nov. 13, 2008, of U.S. Provisional Patent Application No. 61/114,421, entitled “Digital Advertisement Display,” to inventor Genevieve Pacana, all the contents of which are expressly incorporated herein by this reference as though set forth herein in full.

### BACKGROUND OF INVENTION

This invention relates to a digital advertising display apparatus and method of providing controlled content to a digital advertising display. The digital advertising display may be located in a public, private, or retail space. The content provided may be an advertisement that is related to a specific product, informational, educational, or artistic. The content is delivered through wireless communications.

Typically, people receive visual media content on two different devices, the television and the computer. The content for television is typically provided via cable, satellite, or broadcast. Broadcast content is provided free to the consumer, and the broadcast companies make money by selling advertising space in the form of commercials. Although cable and satellite providers charge a monthly fee for providing content, they also sell advertising space in the form of commercials. Other than by changing the channel the user has little control over the television provided content. Content for computers is usually provided through a dial-up or direct cable connection to the internet. However, the connection can include a wireless connection through a router. The content for computers is also paid for by advertising and monthly subscription fees (to access the Internet).

Television content can be passively or actively obtained. The vast majority of content is passively obtained by turning on the television and selecting a channel with pre-programmed content streaming on a specific timed basis. Television is also actively obtained by ordering special events or programs on an on demand, one time basis, or limited time basis. Although televisions frequently have split screen functions so that the user can watch more than one channel at any given time, the programming on more than one channel is not combined to form a single cohesive display.

Computer content is generally actively obtained. The user must connect to the internet and then select specific content to download to or stream onto that computer. Although computer content is often provided in a cohesive display that the user selects, the user is not selecting each element that will be displayed. Instead the user is accepting a generic pre-programmed cohesive display.

Neither the computer model nor the television model is sufficient to deliver a user specified content wherein the user selects what programs (or files) to combine into a cohesive display. Moreover, because the content of computers and televisions already includes those advertisements that are selected by the content provider, the user is unable to select a different advertisement to combine, in a cohesive manner, with the desired content. If the user is able to select specific content and advertising, in a way different than is provided for a computer or a television, the content could then be displayed in a useful way in many settings, including: private spaces; public spaces; and retail spaces. For example, if the private home owner wants to display a specific picture on a display screen, such as a work of art, then the user can obtain, purchase, or rent the picture and have it displayed on a display screen in their home. A computer monitor and a television would be inappropriate for this application. Additionally, if a public space wanted to provide train (or other travel type) schedules and route maps, the user would find televisions inadequate and a standard computer with a monitor inappropriate for this application. Finally, if a retail store wanted to provide both information and specific advertising relevant to what was in the store, a television would be inadequate to actively interact with the shopping user and a computer and monitor would be inappropriate for this application.

Thus, there remains a long felt need in the art for a digital advertising display apparatus and method of providing controlled content to a digital advertising display. The digital advertising display may be located in a public, private, or retail space. The content provided may be an advertisement that is related to a specific product, informational, educational, or artistic. The content is delivered through wireless communications.

### SUMMARY OF THE INVENTION

To minimize the limitations in the prior art, and to minimize other limitations that will become apparent upon reading and understanding the present specification, the present invention discloses a digital advertising display apparatus and method of providing controlled content to a digital advertising display. The digital advertising display may be located in a public, private, or retail space. The content provided may be an advertisement that is related to a specific product, informational, educational, or artistic. The content is delivered through wireless communications.

One embodiment of the invention is a digital advertising display device comprising: a screen, a frame, a local area network inlet, a USB device, a video/audio inlet, a media card reader, a DVD player, an ON/OFF switch, a power cord, a self standing latch, a speaker, a radio frequency receiver, and a separate remote control; a motion detector; wherein the digital advertising display device receives a controlled content from a digital advertising display system and displays the controlled content on the screen; wherein the digital advertising display system comprises a client-side and a server-side, wherein the server-side and the client-side are networked and the server-side is accessible from any networked computer; wherein the digital advertising display device is a high definition liquid crystal display monitor; wherein the radio frequency receiver receives wireless signals; wherein the motion detector starts the controlled content playing on the screen; wherein the frame is simulated canvas; wherein the screen is a touch sensitive display screen; wherein the screen is divided into regions and the controlled content comprises a plurality of sub-content files, such that the regions display different content; wherein the plurality of sub-content files are displayed simultaneously in a seamless manner; and wherein the controlled content includes an one or more advertisement.

Another embodiment of the invention is a method of providing controlled content to a digital advertising display device comprising the steps: providing a digital advertising display device; providing a digital advertising display system; wherein the digital advertising display system comprises a client-side and a server side; wherein the client side and the server side are networked; developing a controlled content; creating the controlled content; producing the controlled content; storing the controlled content in the digital advertising display system; accessing the controlled content; displaying the controlled content on the digital advertising display device; wherein the digital advertising display device comprises: a screen, a radio frequency receiver, a USB device, a video/audio inlet; a media card reader; a DVD player; an ON/OFF switch; a local area network inlet; a power cord; and a speaker; wherein the screen has a plurality of regions that accept a plurality of files to display; wherein the plurality of files are different and wherein the plurality of files are displayed simultaneously; creating the one or more templates; wherein the one or more templates are customizable; wherein the plurality of different simultaneously displayed files are combined on the one or more templates; wherein the digital advertising display system provides the controlled content to the digital advertising display device automatically and wirelessly and wherein the controlled content is automatically updated; wherein the controlled content is accessed and displayed by one or more applications from the group consisting of: a virtual player, a television; a computer desktop; a plurality of streaming internet content; and a media player; and wherein the virtual player is software stored on the client-side.

It is an object of the present invention to overcome the limitations of the prior art.

Another object of the present invention is to provide a digital display device that will display content via several applications, including: a virtual player, television; movies; information; and internet content.

Another object of the present invention is to provide content to the digital display device. The content may come from: a virtual player, television; movies; digital video discs (DVD); compact discs (CD); compact flash memory; static picture files; video files; music files (MP3s, WMAs); streaming internet content; or other advertising files.

Another object of the present invention is to provide a digital display device that comprises a screen, a modem device (and/or a radio frequency receiver, a USB device, a video/audio inlet (cable/television antenna); a media card reader; a DVD player; an ON/OFF switch; a power cord; a self standing latch; a speaker; and a separate remote control.

Another object of the present invention is to provide a virtual player. The virtual player is software that accesses information stored on a server (accessible through the internet or World Wide Web) that renders the display of artwork. Although preferably stored on the client-side, the virtual player may be stored on the server-side without deviating from the scope of the invention.

Another object of the present invention is to have many different applications and uses, including, but not limited to: corporate image promotion; unified information distribution; management for brand franchise stores; announcements at banks, hospitals, and other types of quasi-public spaces; information distribution for a businesses telecommunications, mail, post, and mobile services; information release and notices for scheduled services, such as, rail, air, bus, and other vehicle transportation systems; video advertising systems for office buildings and shopping malls; advertisements for newspaper kiosks and multimedia newspapers; stadium video advertisements and electronic bulletin board systems; and regional notice or advertisements for communities, restaurants, entertainment venues, and other quasi-public, governmental, or retail spaces.

The primary components of the invention are a digital advertising display (DAD) device (hardware) and a computer based DAD system (computer-based software). The DAD device and DAD system are wirelessly networked so that the device receives content from the DAD system and subsequently provides information and advertising content in a public venue, retail environment, or entertainment at a private home (or other private space).

The DAD system (software) may also use existing computer and television screens (as well as many other kinds of display devices) in ways that are as efficient as possible to provide advertising and information to people in public areas.

The DAD device is preferably a digital display or viewing device. The viewing screen is preferably divided into regions and layers, and the content on the screen(s) may be made up of several files.

Preferably, the DAD device is a High Definition display monitor that has the highest resolution available. The DAD device can be any visual monitor, cathode ray tube, plasma screen, Liquid Crystal Display monitor, or Light Emitting Diode monitor. Currently, the preferred monitor is a High Definition Liquid Crystal Display (HD-LCD).

Preferably the DAD has an audio component.

Additionally, the content received by the DAD device may be real-time streaming media, such as Internet Protocol Television (IPTV). The content does not necessarily originate from a single source.

Preferably, the present invention presents content in an automatic way, similar to radio and television, after the user has selected the desired channel. The user does not have to constantly request specific information. Rather, an automated process provides the content (automatically). The key elements of the automatic providing of the content are the schedules and the play-lists.

The content is preferably derived from one or more files being combined into a complete message (or display) on the screen, similar to how content appears on the screen of a personal computer. However, just as with television and contrary to content provided for a computer, the user does not have to actively work to bring up the message on the screen. The message is preferably provided automatically to the end user.

The present invention may also be configured to allow interaction between the user and the DAD device and system. In some applications, the user can control the screen content by selecting or editing play-lists. This could be compared to a television viewer using a remote control device, or touch screen to change channels or select subtitling or alternative languages. The screens are connected to devices that provide the graphical signals that are fed to the screens. However, there are several options when it comes to graphical interfaces, including analog and digital interfaces.

In the present invention, there is frequently a combination of live, near-real-time, and non-real-time information all displayed at the same time. As such, the present invention offers the possibility of simultaneous exposure to commercials, information, and entertainment. The DAD system's content can be tailored to a specific location of the DAD device.

The DAD device screen preferably has many regions and layers, including, but not limited to: animated regions; video regions; aspect ratio regions; layered ticker regions; scrolling text regions; main content regions; information regions; static content regions; and static text regions. The DAD system may be used to provide dynamic digital posters and signs, displays of static or rotating artwork, posters and signs, virtual television channels, movies, internet content, television, advertisements, and live IP radio and television.

The DAD system preferably combines picture elements using play-lists to provide Digital Dynamic Signs and Posters. The DAD system capable of providing the DAD screen a number of images presented in a sequence to form a kind of slide show.

The DAD system may provide virtual television channels. The virtual television channels are more sophisticated than a slide show or dynamic poster. A virtual television channel is created by replacing rotating still images with video clips and playing them all in sequence. A virtual television channel typically requires just one region and one layer.

The present invention preferably includes motion detection technology to promote customer interactivity. The present invention uses motion detectors, near or part of the DAD device, which trigger the play-list in the media player when a customer passes close to the screen. A commercial video clip or an instructional movie clip related to a certain product is then preferably played to the customer. When nobody is near the screen, the play-list preferably just loops over and over again. In this manner, the motion detector solves the problem of how to let the customer watch a promotional or advertisement video without having to wait for it to start all over again. When somebody moves in front of the detector, the media player simply starts the video clip at the beginning of the play-list.

The content provided by the DAD system to the DAD device is preferably provided wirelessly via a network, such as the Internet, an intranet, or the World Wide Web. The content may be manually downloaded and updated, or it may be provided automatically.

### BRIEF DESCRIPTION OF THE DRAWINGS

FIG. 1 is an illustration of a front view of one embodiment of the digital advertising display device.

FIG. 2 is an illustration of a back view of one embodiment of the digital advertising display device.

FIG. 3 is an illustration of a remote control of one embodiment of the digital advertising display device.

FIG. 4 is an illustration of the template management module of one embodiment of the present invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” refers to any device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers; “internet” (or Internet(s)) refers to any collection of networks using standard protocols, whether Ethernet, ATM, FDDI, Wi-fi, Token ring, or any combination thereof; and “website” refers to any document written in a mark-up language including, but not limited to, HTML (hypertext mark-up language) or VRML (virtual reality modeling language), dynamic HTML, XML (extended mark-up language), WML, or any other computer languages related thereto, as well as to any collection of such documents reachable through one specific Internet Protocol Address or at one specific World Wide Web site, or any document obtainable through any particular URL (Uniform Resource Locator); and “web page” (or “page”) refers to any of the various documents and resources on the World Wide Web, in HTML/XHTML format with hypertext links to enable navigation from one page or section to another, or similar such resources used on the internet. FTP is short for File Transfer Protocol, the protocol for exchanging files over the Internet. FTP works in the same way as HTTP (hypertext transfer protocol) for transferring Web pages from a server to a user's browser and SMTP for transferring electronic mail across the Internet in that, like these technologies, FTP uses the Internet's TCP/IP protocols to enable data transfer. FTP is most commonly used to download a file from a server using the Internet or to upload a file to a server (e.g., uploading a Web page file to a server). IPTV is short for Internet Protocol Television. IPTV is a system where a digital television service is delivered using Internet Protocol over a network infrastructure, which may include delivery by a broadband or dial up connection. In general, IPTV is television content that, instead of being delivered through traditional broadcast and cable formats, is received by the viewer through the technologies used for computer networks. IPTV is typically supplied by a service provider using a closed network infrastructure.

The primary components of the invention are a digital advertising display (DAD) device (or screen) (hardware) and a computer based DAD system (computer-based software). The DAD device and DAD system are wirelessly networked so that the screen provides information and advertising content in a public venue, retail environment, or entertainment at a private home (or other private space).

The DAD Device.

The DAD device is preferably a digital display or viewing device. The viewing screen is preferably divided into regions and layers, and the content on the screen(s) may be made up of several files. The regions and layers typically display different content that is combined into one seamless presentation.

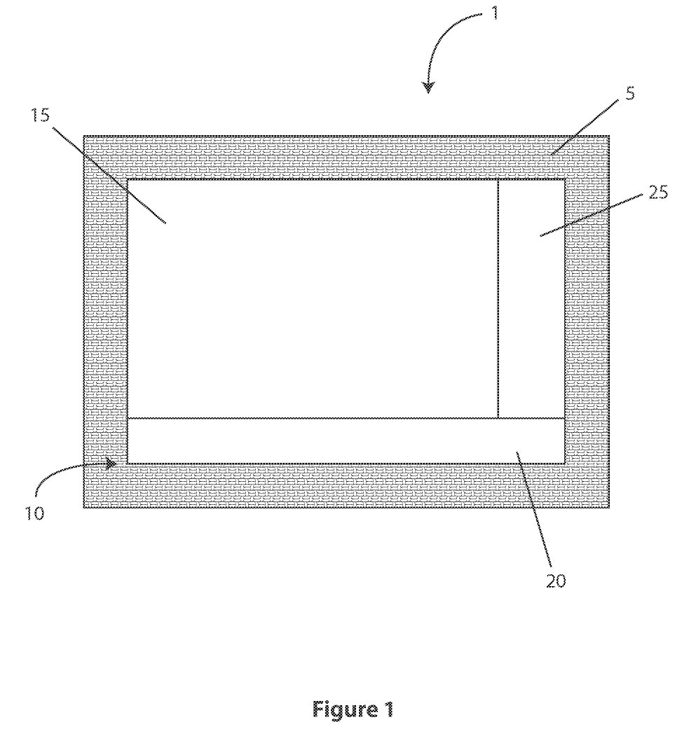

FIG. 1 is an illustration of a front view of one embodiment of the digital advertising display device. As shown in FIG. 1, the front of the digital advertising display (DAD) device 1 has a frame 5 and screen 10. FIG. 1 also shows how the screen is preferably able to be partitioned into different regions, including main content region 15 (also called the video region), ticker region 20 (also called the ratio aspect region, scrolling text region, or text region), and informational region 25 (also called the animated region). Although FIG. 1 shows the screen apportioned in a preferred embodiment, the screen may have any number of regions, and the regions may be apportioned in any manner without deviating from the scope of the invention. Typically, there is only one screen per DAD device. The screen is not physically divided, but rather, the content that is provided to the single screen is electronically divided and shown simultaneously on the screen in the different regions. FIG. 1 shows how the frame 5 preferably looks like simulated canvas (or other fabric). However, frame 5 can be a standard frame without deviating from the scope of the invention. The simulated canvas frame 5 can be made from actual fabric, such as canvas, to give the DAD device a unique and artistic look and feel. However, as preferred, the frame 5 is typically a simulated canvas that is made out of plastic that is shaped to look like a woven material such as canvas. In addition to plastic, the simulated canvas frame 5 can be made out of any material, including but not limited metal; metal alloy; wood or other fibrous plant product such as hemp, paper, or cardboard; glass; composite materials such as graphite, fiberglass, boron, or Kevlar; admixtures of plastic resins combined with metal, metal alloy, wood or other fibrous plant product, glass, or composite materials; plastic; animal materials such as wool, bone, or hardened leather; or any combination of these materials, without departing from the scope of the present invention.

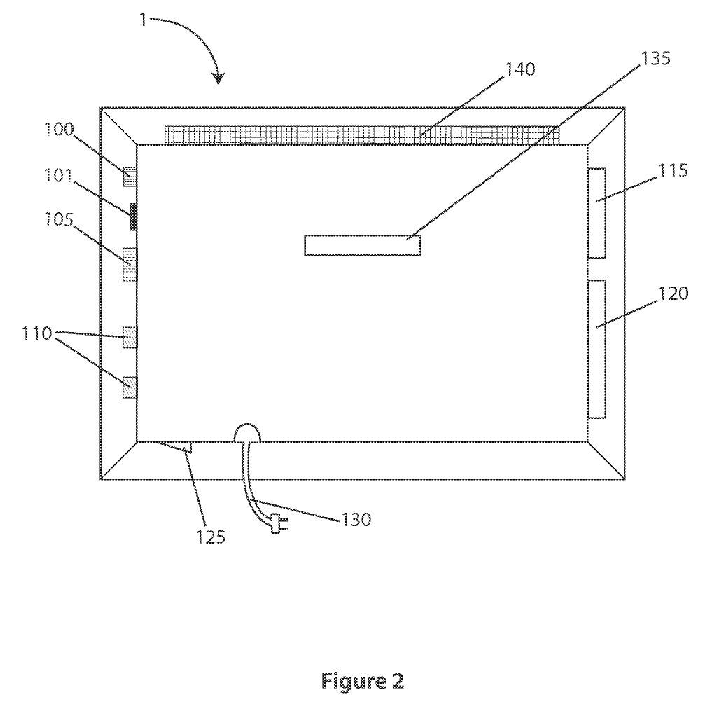

FIG. 2 is an illustration of a back view of one embodiment of the digital advertising display device. As shown in FIG. 2, the digital advertising display device 1 preferably comprises, a local area network device 100, a radio frequency receiver 101, a USB device 105, a video/audio inlet (cable/television antenna) 110; a media card reader 115; a DVD player 120; an ON/OFF switch 125; a power cord 130; a self standing latch 135; and a speaker 140. The DAD device preferably includes an apparatus that provides the graphical signals that are fed to the DAD screens. There are several options when it comes to graphical interfaces, including analog and digital interfaces. For Computer Graphical Interfaces, there are typically two lines of possibilities. The first is from the television business, using television sets and digital video discs (and to a lesser extent VHS VCRs). The other line originates in the computer and Internet oriented world, where the Video Graphics Array (VGA) 15-pin D-Sub connector is the primary interface. The analog HDTV alternative is the Y—Pb—Pr component connection. There are also two digital alternatives: the Digital Video Interface (DVI) and High-Definition Multimedia Interface (HDMI). Although not shown in FIG. 2, the DAD device may have an external antenna or radio frequency receiver to receive broadcasts or wireless communications in addition to or in place of a modem device 100.

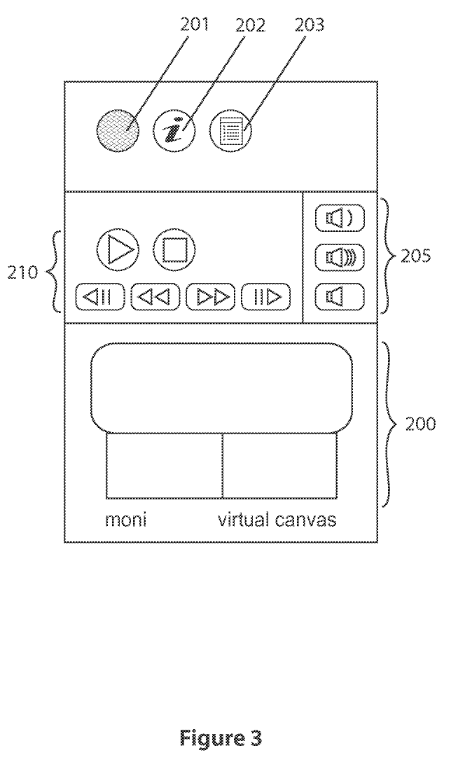

FIG. 3 is an illustration of a remote control of one embodiment of the digital advertising display device. Because the DAD device preferably has no volume or channel controls (unless the DAD device has touch screen capability, in which case volume or channel can be adjusted via a touch screen menu), the DAD device is preferably controlled through a remote control. The remote control preferably works through an infrared signal. As shown in FIG. 3 the remote control preferably includes: a wireless mouse with a laptop designed layout 200; three buttons at the top to control main operations (power on/off 201, internet access 202, and menu 203) (the menu button allows the user to alter the settings of the DAD device, including channel, brightness, and contrast); volume buttons 205; and media control buttons 210.

Preferably, the DAD screen is a High Definition Liquid Crystal Display (HD-LCD). However, because the DAD screen may be located outdoors or indoors and may be very large or very small, several different types of screens may be used. The use of touch screens make it possible for customers/consumers to interact with media players without a keyboard or mouse.

The DAD device typically uses Liquid Crystal Display (LCD) Panels. For screen diagonals smaller than 40 inches (102 cm), the liquid crystal displays are the most cost-efficient flat-panel displays. LCDs are based on a large fluorescent white light source in front of which there is a filter that provides polarized light. In front of this filter is a grid of tiny pixel-sized liquid crystals that can be electrically prodded to twist the polarized light to the same polarization angle as the second polarization filter. In this way, the light is either allowed to pass through or not. Additional filters give the pixels their red, green, and blue colors. The LCD screens are popular because they are very insensitive to burn-in effects, which can be caused by the static content used for advertising.

For outdoor or night time display areas, the use of DAD screens are preferably Light Emitting Diode (LED) display systems. Additionally, there are LCD alternatives that can be used in broad daylight. LCDs consume much less power than LEDs but they cannot be made very large (at least not compared to large-scale LED displays). LCDs also require temperature-controlled, indoor environments.

Moreover, the present invention may use an LCD that is designed to be put in very bright environments, such as store windows. Preferably the LCD DAD screen of this embodiment has a back light consisting of a set of fluorescent lamps, in front of which there is an array of closely tiled optical fibers that get wider as they get closer to the display surface. This magnifies the picture provided by the LCD and rejects incoming light from outside. As a result, a very bright picture with a very small distance between the pixels is achieved. Similarly, large LCD displays use fiber optic techniques to make the screen less sensitive to incoming light. In this display system, fluorescent lamps serve as the back light to optical fibers that are placed very close together and act as light guides to magnify the image from the LCD.

Another way to avoid the problem of sunlight hitting the display and washing out the display is to use the sunlight in a beneficial way through the use of transreflective and reflective LCDs. In transreflective and reflective LCDs, the incoming light can be used to increase the contrast. In the back of the LCD, a retroreflector transmits light from external light sources back through the LCD. In this kind of display, the built-in light source may be switched off (and is typically automatically switched off) when the display is exposed to daylight. This preserves power and makes LCD technology a strong alternative to LEDs for outdoor applications in the long run. Although LCDs are usually made for indoor use, using transreflective LCDs in store windows may overcome the issue of washout from sunlight. Transreflective and reflective LCDs are one way to get low energy outdoor display systems. At night, the built-in light source is used, and in daylight, no light source is required. It should be noted, that the problems of manufacturing large LCD screens, which may be needed to fill a large store window, remain.

The DAD device of the present invention is designed to use both horizontal and portrait orientation. The portrait orientation is quite common to simulate printed posters. Using portrait orientation is also a way to make the DAD device look different from a mere television set. When installing the DAD device, it is important to make sure that it may be installed in portrait orientation because not all display devices are designed for portrait orientation. If portrait orientation is possible, the portrait orientation is very powerful when displaying people in standing or walking positions, such as a video from a fashion show.

The demands for high image resolution vary depending on where the DAD system is located. The highest demands are typically in indoor locations, where the viewer is close to the screen when reading text, such as on customer interface terminals. A common resolution in computer screens of today is SXGA 1280*1024 pixels. This is much better than the standard resolution of television sets and it provides excellent display of text and graphics. Traditional standard television sets have a very low resolution. Even though conventional television sets have meant a lot for the development of in-store television, screen resolution is too low for the reproduction of high quality text messages. For this reason, much of the digital advertising business has been based on computer monitor displays. However, computer screens are not wide enough, and often not big enough, to display commercials at a distance.

Because computer monitors are generally to small and television screens do not have a good enough resolution, the preferred DAD device is an HD-LCD screen. If new technology allows for greater resolution using a device other than an HD LCD, then that new device may be the preferred DAD device. High-definition screens are much improved and better for digital advertising than conventional LCD screen resolutions used to be. The resolutions of 1366*768 and 1920*1080 pixels are in accordance with the 16:9 aspect ratios. Until recently, the resolution of most HD display devices has been limited to 1366*768 pixels. This means that 720p may be an alternative to 1080i since the increased resolution may not be fully used anyway. The 1920*1080 pixel systems are the only systems where the distribution and display formats are the same. This might simplify the image processing in the display devices and could perhaps affect the final quality of the picture to some extent. Thus, although several types of screens may be used, the preferred screen is an HD-LCD screen.

The DAD system.

The DAD system is preferably a network-based Client-side/Server-side local area network system, which is comprised of a client (or client-side) and a server-side. Preferably the client includes the use of set top box (STB) hardware platforms and embedded operating system (preferably Linux 2.4.1), and works according to the server-side settings of play-list for media players. The client preferably updates the play content (audio, video, text, picture, etc.) through remote access (wireless or wired) or a compact flash memory card. The server-side preferably includes management software that is applicable to operating systems (such as Windows 2000/XP/2003) for managing play content, generating play templates, customizing play-lists, managing a FTP server to the play content, and managing and monitoring the clients. The main functions of the server management software include, but are not limited to: managing users; managing resources; managing STB; managing play templates; customizing play content; customizing schedules (tasks); customizing play-lists; monitoring STB; and monitoring FTP downloads and updates.

The digital display device or screen displays (or plays) several applications, including: a virtual player, television; movies; information; internet content; and a computer desktop (preferably Microsoft Windows®). The applications are preferably accessed from a menu screen that is displayed on the DAD screen.

The DAD system, at the most basic level, allows a subscriber, user, or client, to: login into the DAD client-side (with a user name and password that are related to one or more specific DAD devices); access the modules and content stored on the DAD server-side; edit, create, and/or select templates and content; and schedule templates or content to play (or be displayed) on the one or more specific DAD devices. The client-side enables the final display of the content.

The virtual player is the preferred user or client-side software of the present invention that plays or displays the content. The virtual player is accessible through a website or from the computer, server, or local area network that stores the virtual player. The virtual player is the preferred application that provides the DAD screen with images of paintings, sketches, drawings, and other works of art. Ideally, the virtual player is also a program that displays static images (JPEGs) downloaded from the website. Additionally, the virtual player program should be able to retrieve and display picture files (BMPs and JPEGs) from media cards, discs, memory sticks (or keys), and compact discs (CDs) (in addition to those files retrieved from the server-side. The virtual player also preferably plays music (MP3s and WMAs), plays music as background to displayed static images, plays streaming media (audio or video) from the Internet, displays text files or scrolling text displays, and plays advertising content.

The information application preferably plays video content that describes a specific product (when placed next to that specific product) or displays relevant information about the company at which the DAD device is located.

The DAD system provides content to the DAD device. The content may come from or be accessed by: a virtual player, television; movies; digital video discs (DVD); compact discs (CD); compact flash memory drives; music files (MP3s, WMAs); streaming internet content; text files; or other advertising files. Additionally, the content received by the DAD device may be real-time streaming media, such as Internet Protocol Television (IPTV). Content does not necessarily originate from a single source. The DAD system also preferably supports text or photo scrolling displays, insert functions, and custom play templates.

The DAD system, as preferred, provides set top box (STB) monitor function, FTP download monitor function, language switchover (such as Chinese-English), and provides client maintenance and updates on-line.

The DAD system may also use existing computer and television screens (as well as many other kinds of display devices) in ways that are as efficient as possible to provide advertising and information to people in public areas. However, the preferred device, as discussed above, is an HD-LCD screen.

Preferably, the present invention presents content in an automatic way, similar to radio and television, after the user has selected the desired channel. The user does not have to constantly request specific information. Rather, an automated process provides the content (automatically). The key elements of the automatic providing of the content are the schedules and the play-lists.

The content is preferably derived from one or more files being combined into a complete message (or display) on the screen, similar to how content appears on the screen of a personal computer. However, just as with television and contrary to content provided for a computer, the user does not have to actively work to bring up the message on the screen. The message is preferably provided automatically.

The present invention may also be configured to allow interaction between the user and the DAD device and system. In some applications, the user can control the screen content by selecting or editing play-lists. This could be compared to a television viewer using a remote control device, or touch screen to change channels or select subtitling or alternative languages.

The DAD device screen preferably has many regions and layers that can accept different files to display simultaneously, including, but not limited to: Animated Regions; Video Regions; Aspect Ratio Regions; and Layered Ticker Regions. Animated regions (also called information regions) containing a moving message and are designed to catch people's eyes. Video regions (also called main content regions) are where video clips are used to get customers' attention. Advertising commercials can be shown in the video region, or the advertisement may be displayed on the entire screen. The aspect ratio region is that part of the screen that may be available when the content does not utilize the entire height of the screen. Typically, in television, black borders on the top and bottom of the picture compensate for wider ratios. In the present invention, a video clip with a wider aspect ratio can be used as a design element on the screen. It is preferred that the aspect ratio region be used to provide additional content, such as a ticker.

One way to easily show content in all the different regions is to use layers and files with transparency. This makes it possible to superimpose text or graphics on top of other screen content. The present invention preferably features tickers that can run horizontally or vertically on the DAD screen. The tickers may have various colors, not just black and white, and they may be transparent.

The DAD system preferably combines video elements using play-lists. To combine the different content elements of the digital advertising display system the play-lists are built (or programmed) into the DAD system. Play-lists tell the media player in what order and at what time certain files should be shown on the screens. Play-lists can be looped so they start over when they reach their end and are constantly running.

In addition, the DAD system may combine picture elements for simultaneous and consecutive display using play-lists. This combination is preferably called dynamic digital signs and posters. The DAD system is capable of providing the DAD device with a number of images presented in a sequence to form a kind of slide show.

In addition to providing animation, video, still pictures, and ticker information, the present invention may provide content in the form of virtual television channels. The virtual television channels are more sophisticated than a slide show or dynamic poster. A virtual television channel is created by replacing rotating still images with video clips and playing them all in sequence. A virtual television channel typically requires just one region and one layer.

The aim of a virtual television channel is to resemble a conventional television channel, so only one region of the screen is used. A large library of video clips could be combined in different sequences. Changing the content of a virtual television channel is as simple as replacing the play-list. The same files can be reused as elements of different play-lists.

In addition to providing one or more layers and/or regions of video or visual content, the DAD screen preferably also has an audio component. The DAD system provides audio in conjunction with the video content. Moreover, because audio is hard to handle in noisy retail environments and public areas, the DAD device preferably has a directional speaker system that considerably improves the use of audio in noisy venues.

The present invention preferably includes motion detection technology to promote customer interactivity. The present invention uses motion detectors, near, or part of, the DAD screen, which trigger the play-list in the media player when a customer passes close to the screen. A commercial video clip or an instructional movie clip related to a certain product is then preferably played to the customer. When nobody is near the screen, the play-list preferably just loops over and over again. In this manner, the motion detector solves the problem of how to let the customer watch a promotional or advertisement video without having to wait for it to start all over again. When somebody moves in front of the detector, the media player immediately starts the video clip at the beginning of the play-list.

The content provided by the DAD system to the DAD device is preferably provided via a network, such as the Internet, an intranet, or the World Wide Web. The content may be manually downloaded and updated, or it may be provide automatically.

Manually downloading and updating the content. Preferably there is a broadband connection available when manually downloading or updating the content of the DAD system. The first step is to let the user download files manually from a file transfer protocol (FTP) server connected to the content management server. First, files and play-lists are uploaded to the FTP server. Next, the user in any of the DAD device locations logs into the FTP server and downloads the desired files to a local computer (preferably using an FTP client access account). Because the server, computer, and DAD device are all preferably networked, the uploading, updating, and downloading of content may be accomplished from any location. Using an FTP site, many people at many locations can upload or download content to the FTP server. This is one of the most important characteristics of the DAD system: managing the DAD system can be done from any location with an Internet connection.

Providing automatic downloading and updating. Preferably, several times a day and according to a preset schedule, the media players and associated computers access the content management server to check for updated files and/or new files to download.

This relieves the DAD system user from the task of updating the digital systems, and it delegates the responsibility of handling the content to the content management server. This saves time and money and also means improved control of what content is being displayed on the screens. Centrally and automatically downloaded and updated content is preferred over manual downloading and updating.

The network for the DAD system is preferably broadband-based and at its most basic it consists of a content management server and media players. However, the network may alternatively: have an edge server; be based on satellite multicasting and have satellite edge servers; be based on satellite multicasting with media players having integrated multicasting clients; be based on wireless local area network WLAN with media players having integrated multicasting client servers (preferably DAD system supports IEEE 802.11b/g, which is a set of standards implementing WLAN computer communication in the 2.4, 3.6 and 5 GHz spectrum bands, they are maintained by the IEEE LAN/MAN Standards Committee (IEEE 802); or be based on worldwide interoperability for microwave access (WiMAX) (which is a telecommunications technology that provides wireless transmission of data using a variety of transmission modes, from point-to-point links to portable internet access) with media players having integrated multicasting clients.

The user operates the DAD device and the DAD system through a series of steps. First, the desired content is developed, created, produced, or otherwise obtained. Preferably the content communicates the message that the user wants to convey, in a medium or format chosen by the user. The user may create content using audio, video, photography, graphics, text, and/or animation. In the next step, the content is stored on a server (preferably the server-side) and is made accessible for uploading (access is gained through the client-side). This is accomplished by copying the play resource files to the main directory. This way the client-side can access and play this content. The content is managed, scheduled, and monitored by the server-side via a networked environment. The content is then accessed through any workstation or computer connected to the internet and displayed on the DAD device. Preferably, only set top boxes (of DAD devices) previously registered in the server-side (of the DAD system) can connect to the content server correctly.

The DAD device may connect (or network) to the DAD system in several different ways. First, and preferred, the DAD device includes a radio frequency receiver that receives signals from a local wireless network. The local wireless network includes a computer, server, or other storage device that includes the client-side. The local wireless network receives content from the server-side and transmits it to the DAD device. Second, the DAD device includes a local area network inlet and is directly connected to a local area network. The local area network includes a computer, server, or other storage device that includes client-side. The local area network receives content from the server-side and transmits it to the DAD device. Finally, the DAD device includes both a computer, server, or other storage device, which includes the client-side, and a local area network connection. The DAD device, through the local area network inlet, receives, directly, and displays content from the server-side. Although only three specific ways of connecting the DAD device to the DAD system are disclosed, many other different ways are possible so long as the content on the server-side is displayed on the DAD device. The user, subscriber, or client is preferably able to control and schedule content for a DAD device regardless of how the DAD device is networked to the DAD system.

The STB management module is preferably used for STB group management and STB registration. After connecting to the content server with a registered STB, the user has access to the content that has been added and made accessible to the client-side. Preferably the user has access to existing templates, may create customized play templates, or modify existing templates. The template management module is used to accomplish this step. The template management module preferably allows the user to dictate into what regions the DAD device screen will be divided.

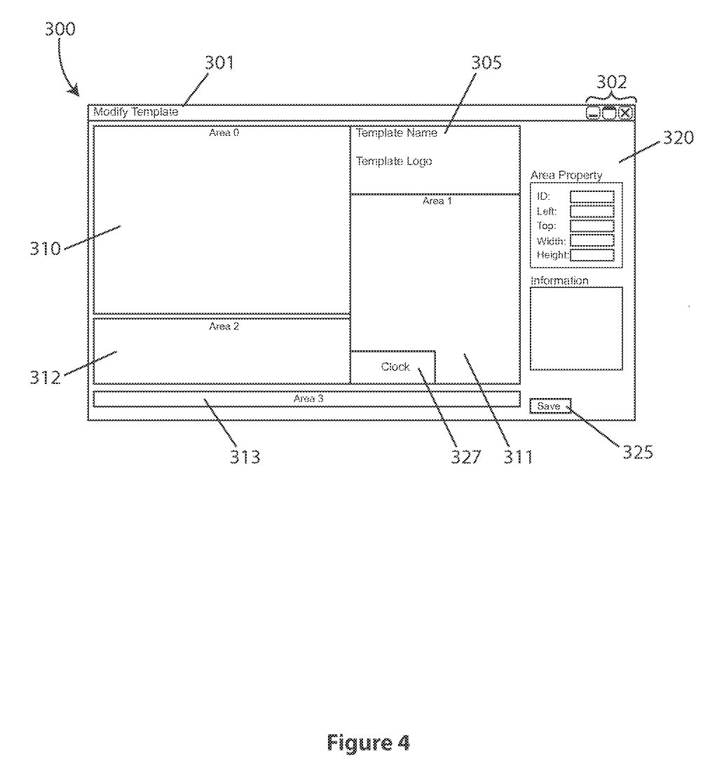

FIG. 4 is an illustration of the template management module of one embodiment of the present invention. As shown in FIG. 4 the template management module 300 allows the user to view: what program is currently running (modify template 301); the minimize/maximize/close interactive buttons 302; the template name and logo 305; the template areas (“Area 0” 310, “Area 1” 311, “Area 2” 312, and “Area 3” 313); the area control 320; the save button 325; and clock 327. The template name and logo 305 also preferable includes additional information about that specific template in addition to reciting the name of the template and showing any artwork associated with the template. The areas represent regions or layers into which the DAD screen is divided. As shown in FIG. 4, “Area 0” 310 is the primary area and preferably hosts the main content file. “Area 1” 311 is preferably informational content and, as shown in FIG. 4, includes a clock 327 that displays the time and date. “Area 2” 312 is another region of the screen where the user can add additional video, graphics, rotating still pictures, logos, or animation. “Area 3” 313 preferably an area that provides scrolling text information. FIG. 4 also shows how the property of each area is customized by entering size information into the area control 320. Area control 320 also allows the user to change the template name, add new areas, or delete existing areas. Once the template is complete, the user clicks the save button 325.

Once the template is set, the next step is to customize the play content. This is done by assigning content (or content file) to related play areas (or regions) of the template. In addition to determining what content will play in each region, the content can be programmed to display at certain times or intervals. This is called customizing the schedule. Preferably, the schedule is customized by setting or entering the task name, state date, end date, start time, end time, and a task description. Because the STB play content, time, and area (region) are all based on the list of the server setting, it is necessary to arrange one or more play tasks for the STB (or STB group) and generate the play-list for download and eventual display. Finally, after an interactive overlay is securely attached over the display and the content is now accessible to the consumer. While the DAD device is in operation, the DAD client-side is constantly networked with DAD server-side. This way the server-side maintains command interaction, timing, and synchronization with the client-side. As such, the client-side is responsive to orders, including, but not limited to: play status inquires, compact flash card status and content inquiries, real-time rolling messages; updates; software upgrades; close; and restart.

Other operations controlled by the server-side of the DAD system include user (client-side) management; STB watch; FTP watch; language switchover (for example Chinese-English); and resetting the main directory. A language switchover is merely changing what language is being displayed. The user may choose any language to display that has been programmed into the system.

In summary, the present invention is a digital advertising display apparatus and method of providing controlled content to a digital advertising display. The digital advertising display may be located in a public, private, or retail space. The content provided may be an advertisement that is related to a specific product, informational, educational, or artistic. The content is delivered through wireless communications.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A digital advertising display device comprising:
a screen, a frame, a local area network inlet, a USB device, a video/audio inlet, a media card reader, a DVD player, an ON/OFF switch, a power cord, a self standing latch, a speaker, and a separate remote control;
wherein said digital advertising display device receives a controlled content from a digital advertising display system and displays said controlled content on said screen;
wherein said digital advertising display system comprises a client-side and a server-side, wherein said server-side and said client-side are networked and said server-side is accessible from any networked computer.

2. The digital advertising display device of claim 1, wherein said digital advertising display device is a high definition liquid crystal display monitor.

3. The digital advertising display device of claim 1, further comprising:
a radio frequency receiver that receives wireless signals.

4. The digital advertising display device of claim 1, wherein said frame is simulated canvas.

5. The digital advertising display device of claim 1, wherein said screen is a touch sensitive display screen.

6. The digital advertising display device of claim 1, further comprising:
a motion detector; wherein said motion detector starts said controlled content playing on said screen.

7. The digital advertising display device of claim 1, wherein said screen is divided into regions and said controlled content comprises a plurality of sub-content files, such that said regions display different content.

8. The digital advertising display device of claim 7, wherein said plurality of sub-content files are displayed simultaneously in a seamless manner.

9. The digital advertising display device of claim 8, wherein said controlled content includes an one or more advertisement.

10. The digital advertising display device of claim 8, wherein said controlled content is selected from the group consisting of: an one or more dynamic digital posters; an one or more dynamic digital signs; an one or more static artworks; and an one or more rotating artworks.

11. The digital advertising display device of claim 8, wherein said controlled content is selected from the group consisting of: an one or more virtual television channels; an one or more videos; and one or more movies; an internet based content; and an one or more television channels.

12. A digital advertising display device comprising:
a screen, a frame, a local area network inlet, a USB device, a video/audio inlet, a media card reader, a DVD player, an ON/OFF switch, a power cord, a self standing latch, a speaker, a separate remote control, a motion detector, and a radio frequency receiver;
wherein said digital advertising display device receives a controlled content from a digital advertising display system and displays said controlled content on said screen;
wherein said digital advertising display system comprises a client-side and a server-side, wherein said server-side and said client-side are networked and said server-side is accessible from any networked computer;
wherein said digital advertising display device is a high definition liquid crystal display monitor;
wherein radio frequency receiver receives wireless signals;
wherein said motion detector starts said controlled content playing on said screen;
wherein said frame is simulated canvas;
wherein said screen is a touch sensitive display screen;
wherein said screen is divided into regions and said controlled content comprises a plurality of sub-content files, such that said regions display different content;
wherein said plurality of sub-content files are displayed simultaneously in a seamless manner; and
wherein said controlled content includes an one or more advertisement.

13. A method of providing controlled content to a digital advertising display device comprising the steps:
providing a digital advertising display device;
providing a digital advertising display system;
wherein said digital advertising display system comprises a client-side and a server side;
wherein said client side and said server side are networked;
developing a controlled content;
creating said controlled content;
producing said controlled content;
storing said controlled content in said digital advertising display system;
accessing said controlled content; and
displaying said controlled content on said digital advertising display device.

14. The method of providing controlled content to a digital advertising display device of claim 13, wherein said digital advertising display device comprises: a screen, a local area network inlet, a radio frequency receiver, a USB device, a video/audio inlet; a media card reader; a DVD player; an ON/OFF switch; a power cord; and a speaker.

15. The method of providing controlled content to a digital advertising display device of claim 14 wherein said screen has a plurality of regions that accept a plurality of files to display.

16. The method of providing controlled content to a digital advertising display device of claim 15, wherein said plurality of files are different and wherein said plurality of files are displayed simultaneously.

17. The method of providing controlled content to a digital advertising display device of claim 16, further comprising:
creating said one or more templates;
wherein said one or more templates are customizable; and
wherein said plurality of different simultaneously displayed files are combined on said one or more templates.

18. The method of providing controlled content to a digital advertising display device of claim 17, wherein said digital advertising display system provides said controlled content to said digital advertising display device automatically and wirelessly and wherein said controlled content is automatically updated.

19. The method of providing controlled content to a digital advertising display device of claim 18, wherein said controlled content is accessed and displayed by one or more applications from the group consisting of: a virtual player, a television; a computer desktop; a plurality of streaming internet content; and a media player.

20. The method of providing controlled content to a digital advertising display device of claim 19, wherein said virtual player is software stored on said client-side.
